(19) United States
(12) Patent Application Publication
(10) Pub. No.: US 2005/0245150 A1
(43) Pub. Date: Nov. 3, 2005

(54) Glass-ptfe textile material

(76) Inventor: Horst-Dieter Rector, Herzogenrath (DE)

Correspondence Address: Purdue Law Offices, Suite B2, 2735 North Holland Sylvania Road, Toledo, OH, 43615-1844, US

(21) Appl. No.: 10/507,985

(22) PCT Filed: Mar. 17, 2003
(86) PCT No.: PCT/DE03/00863

§ 371 Date: Sep. 15, 2004

(30) Foreign Application Priority Data
Mar. 15, 2002 (DE) 10211667.9

(51) Int. Cl. B32B 17/02; B32B 3/00; B32B 17/04; B32B 27/00

(52) U.S. Cl. 442/59; 442/181; 442/187; 442/180

(57) ABSTRACT

The invention relates to a glass/PTFE textile material made from multifilament threads (1), the filaments (2) of which are coated with PTFE, whereby a rubbing of glass on glass in the final product, both between the threads and between the filaments to form pinholes can be reliably avoided. According to the invention, the filaments (2) are coated with sintered PTFE, the cavities (4) between the filaments (2) thus being filled and the outer surfaces of the threads (1) are formed by the coating (3) of the filaments (2).

This invention concerns a textile woven glass-PTFE fabric consisting of multifil weft and warp threads whose filaments are coated with PTFE.

Well-known are all-glass wovens which are subjected to a finishing (coating) operation after the weaving operation. In the finishing (coating) operation, the woven fabric is drenched in a PTFE dispersion. Excess dispersion is subsequently wiped off and then the PTFE is sintered. It is known for the fabric to pass up to 10 times through the drenching-wiping-sintering operation, depending on the desired end product and its use. This gives an end product having a PTFE weight fraction in excess of 60%.

In the end products thus obtained, the warp and weft threads have not been drenched through right into the core. In fact, the dip in the dispersion bath leaves residual air trapped between the filaments, since the compactness of woven fabric assemblies is such that it is inevitable for drenching through to be incomplete. This leads to an appreciable endangering of the material especially at the crossing points of warp and weft threads, since these locations can end up with too little or no PTFE being emplaced there.

When such products are subjected to dynamic stress, there will be rubbing of glass against glass due to contact between the glass threads' circumferential areas being insufficiently coated, if at all, in the crossing points in particular as well as due to the frictional contact between the individual filaments in the threads. A likely consequence is product failure due to destruction of the filaments.

To avoid corrosion at non-protected contact areas or points of woven fabric threads it is already known (DE 41 37 627 A1) to coat the circumferential areas of textile thread-formed structures with high temperature resistant plastic before the desired sheetlike structure is produced. But reliable protection in the case of frictional contact between the circumferential areas of the threads as well as between their filaments cannot be achieved as a result.

It is further to be noted that problems arise with the products in question due to pinholing occurring in the course of the drenching of the woven glass fabric. Pinholes in this context are small channels which can extend from the outside right into the core of the woven fabric and which in some instances pass right through the fabric. They form above the holes in the woven construction which if anything increase in size at the first drench, since thread cross-section always decreases in size when threads are wet and this enlarges the passage space between the threads. In the course of subsequent drenching passes it is then frequently no longer possible to achieve closure of all these holes in the woven construction. This in turn not only compromises the visual appearance of the product, but, through the capillary action of such pinholes, can cause moisture and germs to ingress into the finished product and lead to discoloration, moldiness, loss of integrity and premature aging of the product. This effect is observed especially in the case of architectural membranes which are permanently exposed to extreme weathering influences.

Against that background, then, the present invention has for its object to provide a woven fabric of the kind described at the beginning that reliably avoids glass/glass friction and pinholing in the finished product.

This object is achieved according to the invention when the filaments are coated with fully sintered PTFE, the interspaces between the filaments are fully filled with fully sintered PTFE and the outer surface of the threads is formed by the coating on the filaments.

The consequence is that even before the woven fabric has passed through the finishing operation it is already reliably endowed such that at any rate glass/glass friction both between threads and between filaments is avoided and pinholes are very substantially precluded. A further consequence is the avoidance of undesired inclusions of moisture which might otherwise result due to capillary inclusions in the course of further processing.

The woven fabric of the present invention is further observed to give a lint-free surface and hence precludes surface problems of the finished product which, in the case of prior art glass wovens, constitute the main cause of second-choice production.

The individual threads of the woven fabric do not have any coating which envelopes the entire thread in each case. On the contrary, the coatings on the individual filaments, in the outer zones of a thread, will be found to be sufficient. The consequence is that these threads can be woven up without problems.

The reliable enveloping of the individual filaments has the further consequence that any filaments' portions becoming detached are reliably encapsulated; that is, are not able to egress from the fabric. This is significant, since such portions, especially at a diameter of ≦3μ, are respirable and can lead to serious' health risks when breathed in. This invention accordingly allows the technically and economically optimum diameter for the filaments to be chosen for any one application without having to fear health risks.

It is a further consequence of the reliable enveloping of the individual filaments that their fatigue resistance is appreciably enhanced, so that filaments of larger diameter can be used. This results in cost saving and avoidance of hazardous low filament diameters.

According to the invention, the amount of PTFE applied to any one thread is in the range from 1% to 50% and preferably in the range from 1% to 30% of the weight of the overall thread.

The woven fabric can be produced in many known constructions. The threads used can consist of zero-twist, twisted or folded yarns. They can have different yarn counts and/or different loadings with PTFE.

An embodiment of the present invention's woven fabric will now be described by reference to drawings, in which:

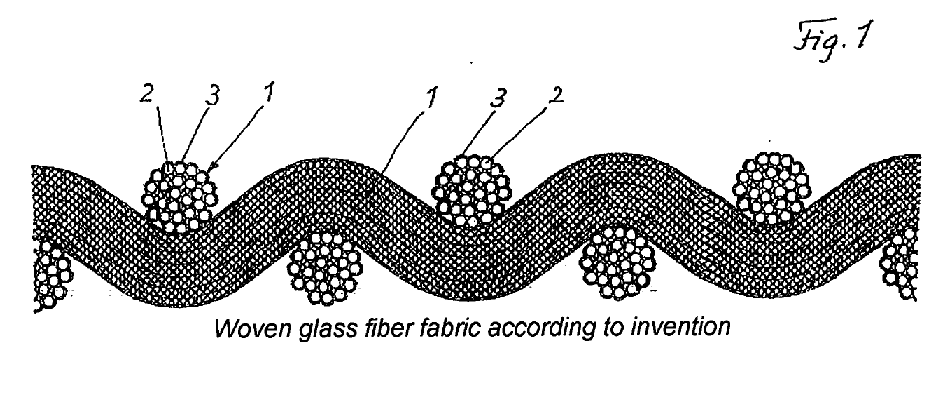

FIG. 1 shows a cross section through the fabric and

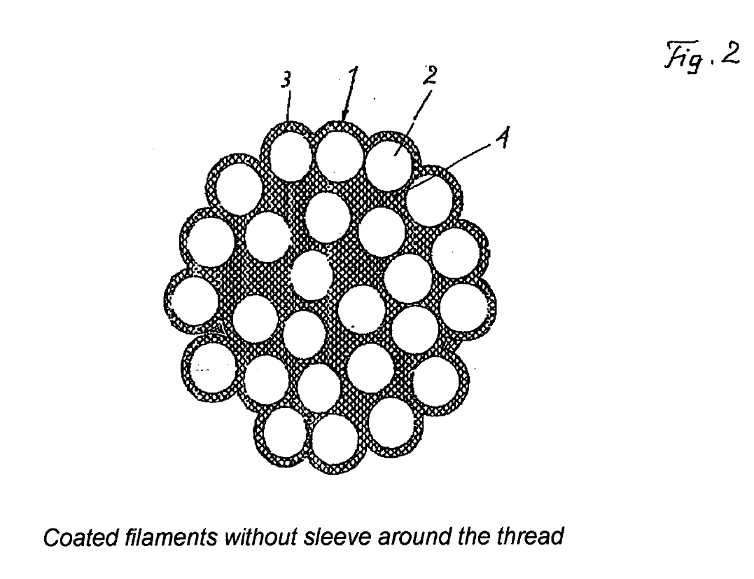

FIG. 2 shows a cross section through a thread.

The thread (1) (FIG. 2) consists of filaments (2) which are coated with PTFE which has already been fully sintered before weaving. The PTFE coating envelops the particular filament (2) and fills up the interspaces (4) between the filaments (2).

The outer contour of the thread (1) is formed exclusively by the envelopes (3) surrounding the individual filaments (2) disposed on the outside of the thread (1). An overall enveloping for the overall thread (1) is not envisaged.

Weaving accordingly leads not to glass coming into contact with glass, but exclusively to the envelopes (3) surrounding the filaments of the warp thread coming into contact with the envelopes surrounding the filaments of the weft thread. This leads to a very strong structure which is capable of resisting dynamic loads and which, after suitable finishing, is especially advantageous for architectural membranes, transportation belts, baking foils and diverse industrial applications. Contact between unprotected filaments is avoided as well.

Two specific operative examples will now be described.

### OPERATIVE EXAMPLE 1

### Use to Produce an Architectural Membrane

| | |
|---|---|
| basis weight: | 630 g/m² |
| glass fraction: | 80% |
| PTFE fraction: | 20% |
| warp: | 19 ends/cm |
| weft: | 18 picks/cm |
| warp material: | 2 × 68 tex 130 Z |
| folded yarn | |
| weft material: | 2 × 68 tex 130 Z |
| folded yarn | |
| construction: | panama |

A fabric strip 5 cm in width is determined to have a breaking strength of 6500 to 7500 N/5 cm in the warp direction. When the fabric is constructed in a conventional manner, breaking strengths of 4500 to 5500 N/5 cm in the warp direction are measured prior to finishing. The process of the present invention thus leads to a more than 50% increase in breaking strength compared with the process employed hitherto.

### OPERATIVE EXAMPLE 2

### Use to Produce a Baking Foil

| | |
|---|---|
| basis weight: | 123.5 g/m² |
| glass fraction: | 82% |
| PTFE fraction: | 18% |
| warp: | 24 ends/cm |
| weft: | 22 picks/cm |
| warp material: | 22 tex 28 Z singles |
| weft material: | 22 tex 28 Z singles |
| construction: | plain weave |

A fabric strip 5 cm in width is determined to have a breaking strength of 1700 to 1800 N/5 cm in the warp direction. When the fabric is constructed in a conventional manner, breaking strengths of 1200 to 1300 N/5 cm in the warp direction are measured prior to finishing. The process of the present invention thus leads to a more than 50% increase in breaking strength compared with the process employed hitherto.

1. A textile woven glass-PTFE fabric consisting of multifil threads (1) whose filaments (2) are coated with PTFE,
characterized
in that the filaments (2) are coated with fully sintered PTFE,
in that the interspaces (4) between the filaments (2) are completely filled with fully sintered PTFE, and
in that the outer surface of the threads (1) is formed by the coating (3) on the filaments (2).

2. The fabric according to any one of the preceding claims that is characterized in that the amount of PTFE applied to any one thread (1) comprises in each case from 1% to 50% of the weight of the overall thread (filaments+coating).

3. The fabric according to claim 1 that is characterized in that the amount of PTFE applied to any one thread (1) comprises from 1% to 30% of the weight of the overall thread.

4. The fabric according to any one of the preceding claims that is characterized in that it has a plain-weave construction.

5. The fabric according to any one of the preceding claims that is characterized in that it has a modified plain-weave construction.

6. The fabric according to claim 5 that is characterized in that it has a panama construction.

7. The fabric according to any one of claims 1 to 3 that is characterized in that it has a twill, satin or double-cloth construction.

8. The fabric according to any one of the preceding claims that is characterized in that warp and weft threads consist of zero-twist, twisted or folded yarns.

9. The fabric according to any one of the preceding claims that is characterized in that warp and weft threads have different yarn counts and/or different loadings with PTFE
